(19) United States
(12) Patent Application Publication
(10) Pub. No.: US 2011/0016206 A1
(43) Pub. Date: Jan. 20, 2011

(54) SYSTEMS AND METHODS FOR CREATING USER INTEREST PROFILES

(76) Inventors: Muralidharan Sampath Kodialam, Marlboro, NJ (US); Tirunell V. Lakshman, Morganville, NJ (US); Sarit Mukherjee, Marlboro, NJ (US); Limin Wang, Plainsboro, NJ (US)

Correspondence Address: HARNESS, DICKEY & PIERCE, P.L.C., P.O. BOX 8910, RESTON, VA, 20195, US

(21) Appl. No.: 12/503,265

(22) Filed: Jul. 15, 2009

(51) Int. Cl. G06F 7/10; G06F 17/30; G06F 15/16

(52) U.S. Cl. 709/224

(57) ABSTRACT

Example methods include monitoring Internet traffic for a user, analyzing content of the Internet traffic, correlating the analyzed content with a simplified classifier set, ranking each correlated simplified classifier in the simplified classifier set, and storing the ranked simplified classifiers in a user interest profile for the user. Customer premise equipment may include a residential gateway, such as a wireless router, and user equipment such as a personal computer. Example systems may be configured from customer premise equipment or Internet service providers to generate user interest profiles in accordance with example methods.

### BACKGROUND

1. Field

Example embodiments generally relate to systems and methods of creating user interest profiles with by analysis of internet traffic requested and retrieved by the users.

2. Description of Related Art

FIG. 1 is an illustration of a conventional Internet networking scheme 100. As shown in FIG. 1, one or more pieces of user equipment (UE) 145 are communicatively connected to a networking hub 140. UEs 145 may include, for example, personal computers, mobile telephones, personal data assistants, game consoles, Internet-Protocol Televisions, etc. capable of sending and receiving data to/from networking hub 140, via a wired or wireless connection. Networking hub 140 may include, for example, a wireless access point or router in a commercial or workplace setting, and/or a residential gateway such as a wireless router, a cable modem, a DSL modem, etc. Networking hub 140 may also include a combination of several devices, such as in the case of residential gateways including a cable modem connected to a wireless router associated with multiple UEs 145 within a single residence, for example. All equipment located at a particular site, including UEs 145 and networking hub 140, is referred to as customer premise equipment (CPE) 120. In this way, the different CPEs 120 shown in FIG. 1 may be separate businesses, residences, and/or other locations.

Conventionally, networking hub 140 is communicatively connected to remote or network-level Internet Service Provider (ISP) equipment 150 through ISP connection 170. ISP equipment 150 may include a number of network-level computers, switches, servers, etc. that connect to/network with the general internet 160. Through a network-level ISP equipment 150, Internet access may be granted to several distinct individual networking hubs 140 and UEs 145 associated therewith. ISP equipment 150 may further include network-level storages and processors that further store content and/or deliver services to CPE 120. For example, ISP equipment 150 may include email application and storage, user account authentication information, network analysis and optimization applications, etc.

Conventionally, information regarding interests and Internet usage habits of individual UEs 145 and users of the same are aggregated and stored in a network-level user interest profile 155 controlled by the ISP. ISPs may generate user profiles by recordation and analysis of each UEs 145 data requests and retrievals from internet 160, because such data passes through ISP equipment 150. Another conventional method of generating user interest profiles 155 is by individual website providers in Internet 160, such as a search engine, storing and analyzing user interactions therewith in order to generate a user interest profile. Because ISP equipment 150 and/or internet website providers may include several processors, large bandwidth availability, and other resource-intensive analysis tools, user profiles 155 may be feasibly generated and stored with the ISP or internet content provider, because UEs 145 data requests and retrievals may require larger amounts of internet-based information page “reading,” data-mining, ranking, sorting, and/or other analysis in order to generate user profiles 155 that are useful summaries of users' interests and/or habits based on internet-based information submitted and retrieved.

### SUMMARY

Example embodiments include systems and methods of creating user interest profiles with customer premise equipment by analysis of internet traffic requested and retrieved by the users. Example methods may include monitoring internet traffic for a user, analyzing content of the internet traffic, correlating the analyzed content with a simplified classifier set, ranking each correlated simplified classifier in the simplified classifier set and storing the ranked simplified classifiers in a user interest profile for the user. Customer premise equipment may include a residential gateway, such as a wireless router, and user equipment such as a personal computer. Example systems may be configured from customer premise equipment to generate user interest profiles in accordance with example methods.

User interest profiles include simplified lists of classifiers and weightings that may consume minimal storage resources on customer premise equipment. Example methods may generate user interest profiles while consuming less processing, network bandwidth, and/or storage resources, so that example methods may be executed on conventional customer premise equipment that is modified with appropriate programming and connectivity. Because example user interest profiles are generated and ultimately stored entirely in customer premise equipment within the control and/or ownership of the individual users associated with the profiles, example methods and systems may reduce the risk of user profile misuse or theft and may increase user accessibility to user interest profiles.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is an illustration of a conventional internet networking scheme.

FIG. 2 is an illustration of an example embodiment internet networking scheme.

FIG. 3 is an illustration of an example method of generating a user interest profile.

### DETAILED DESCRIPTION

Detailed illustrative embodiments of example embodiments are disclosed herein. However, specific structural and functional details disclosed herein are merely representative for purposes of describing example embodiments. The example embodiments may, however, be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected,” “coupled,” “mated,” “attached,” or “fixed” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

As used herein, the singular forms “a”, “an” and “the” are intended to include the plural forms as well, unless the language explicitly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially and concurrently or may sometimes be executed in the reverse order, depending upon the functionality/acts involved.

Although the figures and description use several terms and indicators to depict communicative connection between elements of example embodiments, it is understood that two distinct elements may be communicatively connected through wireless or physical media, including electromagnetic radiation and metallic cables, for example.

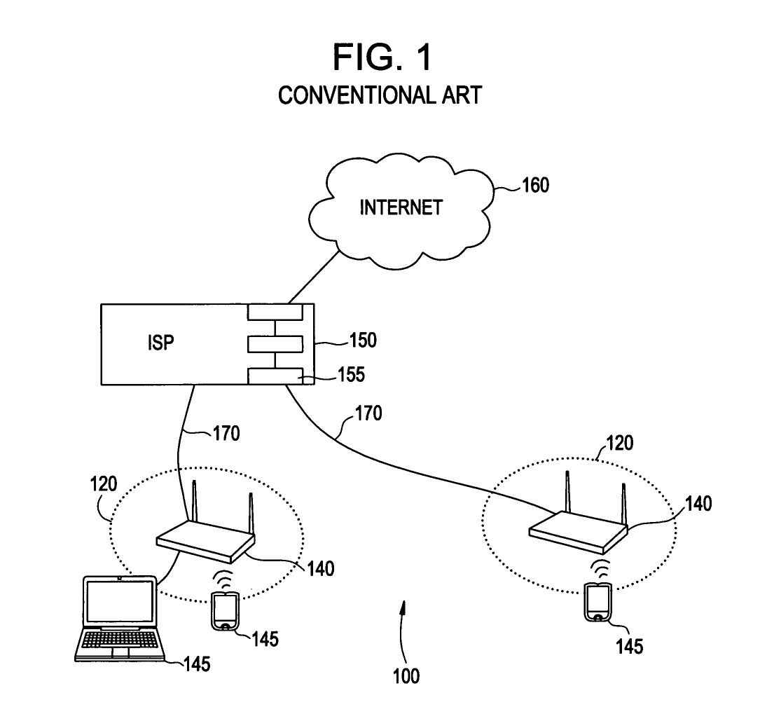

The inventors have recognized that generating and/or storing a user profile at a network-level location, such as ISP equipment 150 or with an individual webpage provider in internet 160 in FIG. 1, may pose security concerns for individual users of UEs 145. For example, interests, internet usage habits including past internet-based purchases, and/or other personal information stored in user profiles with the ISP or internet website may be outside the control of individual users and/or may be subject to misuse by the ISP/website. When user profiles are generated and stored in network-level ISP equipment 150 or individual website providers, thieves targeting information in user profiles need target only a single location in order to steal user information for potentially thousands of users.

The inventors have recognized that individual webpages or other content providers on internet 160 may be able to collect only a fraction of all information submitted and retrieved by users of UEs 145, since user interactions with different websites may not be known to each other website. This may prevent the generation of robust and/or accurate user interest profiles. The inventors have further recognized that customer premise equipment (CPE) 120 may lack the programming and storage and processing ability to generate and store conventional user profiles. In order to address these and other problems and/or in order to provide advantages over the conventional art described above, the inventors have conceived systems and methods for successfully generating and storing user profiles on CPE 120, or any other network equipment, including ISPs, described below by way of example embodiments.

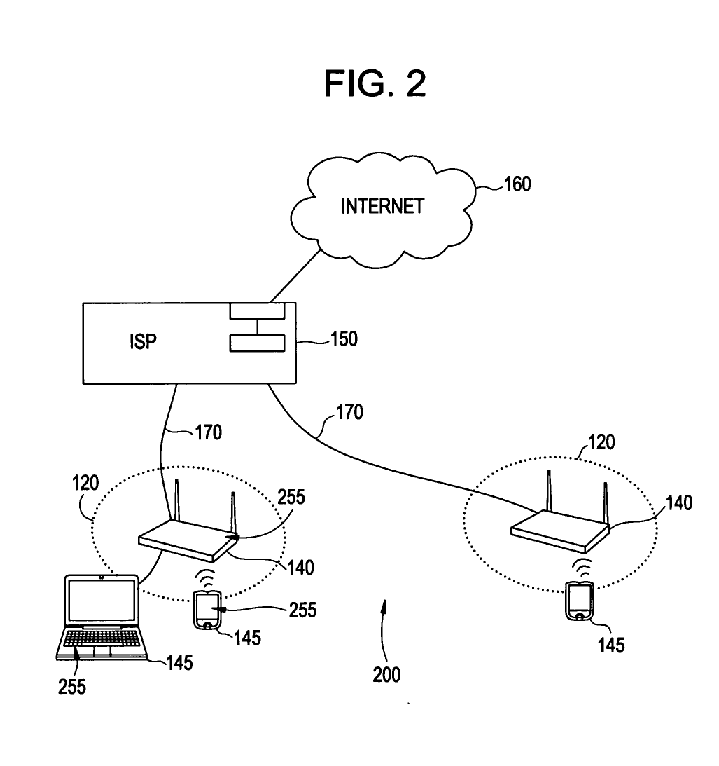

FIG. 2 is an illustration of an example embodiment networking system 200 useable with example methods (discussed below) that may permit faster and/or more secure user interest profile generation and storage. As shown in FIG. 2, example embodiment system 200 may include several conventional pieces of equipment that are described above in FIG. 1 with similar labeling and whose redundant description is omitted. In example embodiment system 200, a piece of CPE 120, including one or more pieces of user equipment 145 and/or network hub 140, generates and stores an example embodiment user interest profile 255 (discussed below with example methods). For example, a laptop computer 145 may generate and store example embodiment user interest profile 255. Alternately, a network hub 140, which may be a residential gateway such as a wireless router associated with several pieces of user equipment 145, may store example embodiment user interest profile 255. In this way, example system 200 may generate and store example embodiment user interest profiles 255 in CPE 120 that is within the possession and/or control of individual users. This may prevent or reduce problems associated with website and/or ISP control and/or ownership of user interest profiles.

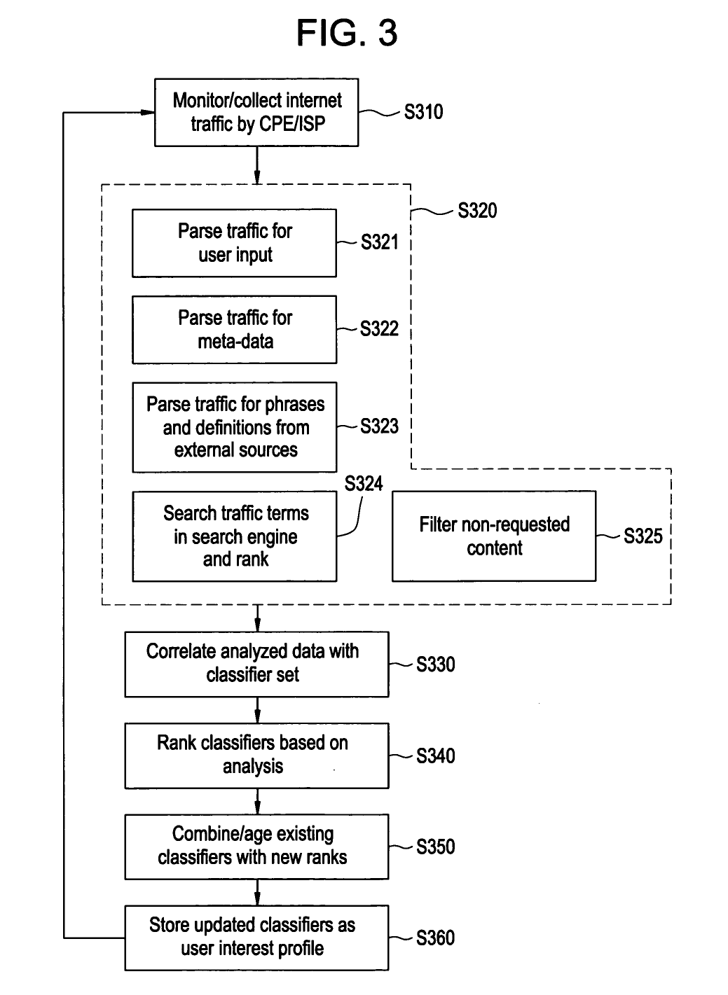

FIG. 3 is a flow chart illustrating an example method of generating an example embodiment user interest profile useable with example systems, such as user interest profile 255 on CPE 120 (FIG. 2). Although example methods are discussed as executed on CPE 120, it is understood that example methods may be executed by other network equipment and/or parties, such as ISP 150 (FIG. 2).

As shown in FIG. 3, the CPE monitors and/or collects all internet traffic being requested and retrieved by users of the UEs 145 in step S310. The monitored or recorded internet traffic may include, for example, webpage URL and/or content, streaming media, file downloads, internet chat, and/or any other information conventionally requested and retrieved from the internet. Step S310 may be executed by individual pieces of UEs 145 (FIG. 2) or programs thereon; alternatively, step S310 may be executed by networking hub 140, such as a residential gateway. As an example, if a residential gateway, such as a wireless router in a home, is used to execute step S310, all Internet traffic for a given location/household may be monitored by a single piece of equipment, while still differentiating among individual users based on different UEs and generating unique user interest profiles for each user.

In step S320, the CPE analyzes the Internet traffic monitored and/or stored in step S310. The analysis in step S320 may be accomplished in real time with Internet traffic flow monitored in step S310, and/or the analysis in step S320 may be performed on internet traffic that has been previously collected and stored in step S310. Several different types of analysis may be performed in step S320 in order to determine user interests and browsing habits for inclusion in a user interest profile. The following discussion of example types of analysis may be in conjunction with other, known types of analysis. Similarly, the following example types of analysis may be executed alone, in combination, in any order, and/or repetitively.

One example analysis type, in step S321, includes parsing the Internet traffic for user input. User input may include, for example, search terms input into a search engine, product names put into an online retailer's ecommerce site, user names put into an online mail service, etc. User input may be extracted from URLs by simple parsing of the URL string. Similarly, user input may be extracted from webpage forms, user clicks, programming instructions, and/or other user interactions with an Internet-based resource. Because step S321 may be executed with simple parsing and filtering to determine user input, little processing and other resource burden may be placed on the CPE executing step S321.

Another example analysis type, in step S322, includes parsing the internet traffic for meta-data. Meta-data includes, for example, simple tags identified in html code, page titles, file names, hyperlinks, captions, and/or other simple descriptors of Internet traffic. Meta-data may be extracted from internet traffic by simple parsing of the html or other Internet data information. Because step S322 may be executed without downloading and/or analyzing the complete Internet traffic content but instead may parse out only relevant meta-data descriptors, less storage, bandwidth, and/or processing resources may be consumed by the CPE executing step S322.

Yet another example analysis type, in step S323, includes parsing the Internet traffic for phrases and/or slang by cross-referencing Internet traffic against an external resource. Example external resources include, for example, online dictionaries and community-driven knowledge bases, such as Wikipedia, that are readily accessible through any Internet connection and may deliver simple-text based search results for input phrases and/or slang. Phrases and/or slang may include multi-word terms and/or a term with several alternate meanings that are not readily apparent from parsing individual words from Internet traffic. For example, if an html page title is “Holy Roman Empire,” verifying the term against an online dictionary or community-driven knowledge base may verify that a “Holy Roman Empire” is different content from something “holy,” “Roman,” or an “empire” parsed alone. Step S323 may be executed with only text-based search results for term verification, such that minimal network bandwidth and/or processing resources may be consumed by the CPE executing step S323.

Still another example analysis type, in step S324, includes inputting terms from the internet traffic into a search engine and ranking the internet traffic based on its appearance in the search results. For example, a sports and recreation website delivering content including “baseball,” “box score,” and “weather” may be in the top search results for “baseball” or “box score” but not for “weather.” Based on these results, the page may be appropriately associated with baseball and box scores in step S324 but not with weather. Step S324 may be executed with only text-based search results for term popularity and correspondence to page content, such that minimal network bandwidth and/or processing resources may be consumed by the CPE executing step S324.

A further example analysis type, in step S325, includes filtering or excluding content from internet traffic that is not highly correlated with user interests or habits. For example, internet traffic that is provided without user request, such as advertising, may be filtered from any analyzed content. Similarly, downloaded file types that provide content outside the control of the internet user, such as files with extensions .js, .jpg, .mp3, or auto-refreshing pages, may be screened out in step S325. In this way, the only content and analysis provided in step S320 may be content that is user-requested or corresponds strongly with user actual interests. step S325 may be executed with only file extension screening and/or tags on content provided without user interaction, such that minimal network bandwidth and/or processing resources may be consumed by the CPE executing step S325.

As discussed above, example analyses steps S321, S322, S323, S324, and/or S325 may be useable alone or in combination, sequentially or in any order. For example, user input may be extracted in step S321 and then ranked in a search in step S324. Or, for example, a media file title being downloaded may be extracted in step S322 and then parsed for phraseology or slang in step S323. Similarly, example analyses step S321, step S322, step S323, step S324, and/or step S325 may be repeated as additional Internet traffic information is monitored in step S310 or otherwise becomes available. The example analyses discussed in connection with step S320 may also be combined with other, known types of analyses.

Step S320 may be executed by the same piece of CPE as step S310 or by different pieces of CPE. For example, a residential gateway monitoring Internet traffic in step S310 may further execute the analysis of that data in step S320. If only low-resource-consuming analyses are executed in step S320, including example analyses step S321, step S322, step S323, and/or step S324, the total amount of resources consumed by step S320 may be relatively low and capable of being performed on/by conventional CPE 120 (FIG. 2) adapted with appropriate programming.

In step S330, the analyzed data generated in step S320 is correlated to a simplified classifier set. Example classifier sets may include a list of simple descriptors that classify multiple pieces of Internet traffic content and analysis into relatively shorter terms. For example, content and/or analysis returned from step S320 including “cars,” “Chevy,” “NASCAR,” and “vans” may all be correlated to the simplified classifier “automobiles.” Example classifier sets may be stored as simple tables on CPE 120, and in step S330, the CPE may cross-reference the simple table with the returned content and/or analysis without consuming large amounts of processing resources. An example table containing an example classifier set is shown below in Table 1.

TABLE 1
Example Classifier Set Table

| Content/Analysis generated by CPE in step | |
|---|---|
| S320 | Simplified Classifier |
| “cars,” “vans,” “motorcycles,” “Chevy,” “Ford,” | automobiles |
| “Toyota,” “General Motors,” “NASCAR,” “Indy | |
| Car,” “MPG,” “horsepower” | |
| “forecast,” “precipitation,” “driving conditions,” | weather |
| “temperature,” “UV Index,” “wind speed” | |
| “enamel,” “primer,” “latex,” “Dutch Boy,” | painting |
| “Duron,” “brushes,” “rollers,” “canvas” | |
| “blood pressure,” “vitamin C,” “balding,” | health |
| “saturated fat,” “ulcer,” “life expectancy” | |

Any number of classifiers and correlated terms may be present in example classifier set tables, depending on resources available and desired accuracy. Internet traffic content may fall into several categories, and terms may correspond to multiple simplified classifiers. For example, “enamel” could be correlated with both simplified classifiers “painting” and “health.” Similarly, some content and/or analysis thereof may be sufficiently obscure and/or indeterminate/non-descriptive so as to correlate with no simplified classifier. For example, the term “two” alone may not correlate with any particular simplified classifier.

Analysis in step S320 may provide additional simplified classifiers for correlation in step S330, potentially in conjunction with a classifier set table. For example, an example analysis of step S323 or step S324 may identify that “General Motors” is a phrase labeling a type of automobile or ranks highly on searches for automobiles, indicating that the term “General Motors” should be correlated to the simple classifier “automobiles” in step S330. Through example methods using example classifier set tables and/or example analyses discussed above, internet content may be most closely correlated to a simple identifier reflecting the interests and habits of a user requesting and/or receiving the internet traffic.

Once the internet traffic and/or analysis thereof has been correlated to a simplified classifier in step S330, the simplified classifiers are weighted in step S340, based on their prevalence and/or analysis in step S320. For example, Internet traffic and analysis resulting in correlations of “automobiles,” “automobiles,” and “health” in step S330 may be assigned a weight of {(automobile, 0.67), (health, 0.33)}. Any type and precision of weighting may be used in example methods, and any number of correlations may be weighted in example methods, depending on resources available and the desired completeness of generated user interest profiles.

Other analysis in step S320 may additionally be applied in the weighting in step S340. If analysis step S324, for example, determines that internet traffic appears prominently in search results for “automobiles” but does not rank in search results for “health,” and additional multiplier or other algorithms may be applied to increase the weight of automobile over health. For example, a weight of {(automobile, 0.80), (health, 0.30)} may be calculated based on the analysis and correlation in step S320 and step S340 (weights need not add to 1 under this example scheme).

The correlation and weighting in step S330 and step S340 may be performed by simple searching and weighting algorithms that do not consume large storage or processing resources in CPE 120 (FIG. 2). In this way, step S330 and step S340 may be performed by any conventional CPE 120 modified with appropriate programming. Similarly, step S330 and step S340 may be performed by different or same pieces of CPE 120, none of which may be the same as CPE performing step S310 or step S320, as long as information may be shared among the various pieces of the CPE performing these example methods. Alternatively, a single piece of the CPE, such as a residential gateway, may perform all steps step S310-step S340 without need to communicate data externally.

The weighting generated in step S340 may be stored in step S360 as a user interest profile. Alternatively, the weighting generated in step S340 may be combined with previously-existing weightings, which may be aged, based on internet traffic in step S350. Existing classifiers may be stored or otherwise exist in CPE based on previous or contemporaneous browsing events. For example, it is possible that example methods including steps S310-S340 are performed on a page request basis, a browsing session basis, an email sending basis, a file download basis, a daily basis, etc. In this way, several different sets of weighted simplified classifiers may be present for each user over any desired interval. Or, an existing set of weighted simplified classifiers, stored in a previous iteration of step S360, may be loaded from an existing user interest profile for a same user. For example, if steps S310-S340 are performed on a page request basis, and a user visits twelve different pages, then twelve unique sets of weighted multipliers may be generated in steps S310-S340. In step S350, these twelve sets may be combined. The combination in step S350 may be accomplished through simple arithmetic averaging and/or any other known and desired combinational algorithms. Or, for example, steps S310-S340 may be performed on a daily basis, and preexisting weighted classifiers may be loaded from an existing user interest profile, such that, at the end of the day, a set of weighted classifiers for that day and a set of weighted classifiers may be combined in step S350.

Further, in step S350, older and/or preexisting weighted classifiers may be reduced in importance, or aged, when calculating a new combined set of weighted classifiers with the preexisting weighted classifiers. From the above example using a page request basis for executing steps S310-S340, weighted classifier sets from older page requests, for example, more than twenty page requests ago, may be reduced in value in the combining step S350. For example, if a simple arithmetic mean is used to calculate weighting value among all outstanding weighted classifier sets, preexisting weighted classifiers from more than twenty page requests ago may be multiplied by 0.9 in the combination. Decreased weightings may be applied to even older preexisting weighted classifies combined in step S350. In this way, newer and more accurate user interests and habits may be given increased emphasis in example user interest profiles.

In step S360, the user interest profile may be saved in a piece of CPE. Example embodiment user interest profiles may be a simple table of weighted classifiers for each user. Table 2 illustrates example user interest profiles for individual users of UEs 145.

TABLE 2
Example User Interest Profile

| User | Weighted Classifier Set |
|---|---|
| User A | {(automobiles, 0.44), (running, 0.35), (personal finance, |
| | 0.25), (weather, 0.15)} |
| User B | {(gardening, 0.65), (health, 0.50), (retirement, 0.25), (estate |
| | planning, 0.25)} |
| User C | {(music videos, 0.33), (dating, 0.33), (fashion, 0.33)} |
| User D | {(sports, 0.08), (health, 0.07), (travel, 0.07), (real estate, |
| | 0.05), (weight lifting, 0.04), (nutrition, 0.04), (religion, |
| | 0.02)} |

Any number of different classifiers may be available for each user, and any degree of precision may be retained for the individual weightings. Classifiers having a weight falling below a desired threshold may be eliminated from a user's weighted classifier set, in order to maintain accuracy and control the size of user interest profiles generated in example methods.

As discussed with respect to step S310-step S350, the weighted classifiers stored in the user interest profile may be calculated from several generated weighted classifier sets by iterations of step S310-step S350. Additionally, saving the user interest profile in step S360 may occur on a real-time basis with step S310-step S350 and Internet traffic flow. In this way, user interest profiles may be constantly updated and/or recombined with the newest and most accurate weighted classifier sets for each user, as shown by the loop from step S360 to step S310 in FIG. 3. Alternatively, step S360 may be executed at only specific times or in conjunction with particular browsing events, such as a page request, file download, user input, etc.

Because example user interest profiles may be simplified lists of classifiers and weightings, the profiles may consume minimal storage resources on CPE 120. Further, because example methods may require lower processing, network bandwidth, and/or storage resources in order to generate accurate user interest profiles, example methods may be executed on conventional CPE 120 that is modified with appropriate programming and connectivity. Because example user interest profiles are generated and ultimately stored in CPE 120 within the control and/or ownership of the individual users whom they describe, example methods and embodiments may reduce the risk of user profile misuse or theft and may increase user accessibility to user interest profiles. Users may, for example, determine programming or applications that may interest them based on their user interest profile. Or, for example, users may sell their profiles to advertisers in order to receive targeted advertising.

Example embodiments and methods thus being described, it will be appreciated by one skilled in the art that example embodiments may be varied through routine experimentation and without further inventive activity. For example, although various example methods and devices have been described as being performed on a residential gateway such as a wireless router, it is understood and easily achieved to perform example methods with personal computers. Variations are not to be regarded as departure from the spirit and scope of the exemplary embodiments, and all such modifications as would be obvious are intended to be included within the scope of the following claims.

What is claimed is:

1. A method of generating a user interest profile with at least one piece of customer premise equipment (CPE), the method comprising:
monitoring, by the CPE, internet traffic for a user;
analyzing, by the CPE, content of the Internet traffic;
correlating, by the CPE, the analyzed content with a simplified classifier set;
ranking, by the CPE, each correlated simplified classifier in the simplified classifier set; and
storing, on the CPE, the ranked simplified classifiers in a user interest profile for the user.

2. The method of claim 1, further comprising:
combining, by the CPE, the ranked simplified classifiers with preexisting ranked simplified classifiers.

3. The method of claim 2, wherein the combining includes decreasing a weight of the preexisting ranked simplified classifiers if the preexisting ranked simplified classifiers exceed an age threshold.

4. The method of claim 1, wherein the ranking includes assigning a weight to each simplified classifier based at least on a frequency of appearance of the simplified classifier.

5. The method of claim 1, wherein the analyzing includes at least one of parsing the Internet traffic for user input, parsing the internet traffic for meta-data, comparing the Internet traffic to external knowledge databases in order to define terms of the internet traffic, searching for terms of the Internet traffic in a search engine, and ignoring content of the internet traffic that is not user requested.

6. The method of claim 5, wherein the ranking includes assigning a weight to each simplified classifier based at least on a frequency of appearance of the simplified classifier and the analysis.

7. The method of claim 1, further comprising:
repeating the monitoring, analyzing, correlating, ranking, and storing on a desired basis.

8. The method of claim 7, wherein the desired basis is one of a time basis and a browsing event basis.

9. A method of generating a user interest profile with at least one piece of network equipment, the method comprising:
monitoring internet traffic for a user;
analyzing content of the internet traffic;
correlating the analyzed content with a simplified classifier set;
ranking each correlated simplified classifier in the simplified classifier set; and
storing, on the network equipment, the ranked simplified classifiers in a user interest profile for the user.

10. The method of claim 9, further comprising:
combining the ranked simplified classifiers with preexisting ranked simplified classifiers, the combining including decreasing a weight of the preexisting ranked simplified classifiers if the preexisting ranked simplified classifiers exceed an age threshold.

11. A system for generating user interest profiles on customer premise equipment (CPE), the system comprising:
a plurality of pieces of CPE, including at least one piece of user equipment and at least one network hub,
the plurality of pieces of CPE being communicatively connected to each other and to the Internet,
at least one of the plurality of pieces of CPE being configured to,
monitor Internet traffic for a user,
analyzing content of the Internet traffic,
correlate the analyzed content with a simplified classifier set,
rank each correlated simplified classifier in the simplified classifier set, and
store the ranked simplified classifiers in a user interest profile for the user.

12. The system of claim 11, wherein the at least one network hub is a wireless router and the at least one piece of user equipment is a personal computer.

13. The system of claim 11, wherein the at least one piece of CPE is further configured to combine the ranked simplified classifiers with preexisting ranked simplified classifiers.

14. The system of claim 13, wherein the at least one piece of CPE is further configured to decrease a weight of the preexisting ranked simplified classifiers in the combining if the preexisting ranked simplified classifiers exceed an age threshold.

15. The system of claim 11, wherein the at least one piece of CPE is further configured to assign a weight to each simplified classifier based at least on a frequency of appearance of the simplified classifier.

16. The system of claim 11, wherein the at least one piece of CPE is further configured to parse the Internet traffic for user input, parse the Internet traffic for meta-data, compare the Internet traffic to external knowledge databases in order to define terms of the Internet traffic, search for terms of the internet traffic in a search engine, and ignore content of the Internet traffic that is not user requested.

17. The system of claim 16, wherein the at least one piece of CPE is further configured to assign a weight to each simplified classifier based at least on a frequency of appearance of the simplified classifier.

18. The system of claim 11, wherein the at least one piece of CPE is further configured to repeatedly monitor, analyze, correlate, and rank the Internet traffic and store the user interest profile on a desired basis.

19. The system of claim 18, wherein the desired basis is one of a time basis and a browsing event basis.
